(19) United States
(12) Patent Application Publication
(10) Pub. No.: US 2007/0124953 A1
(43) Pub. Date: Jun. 7, 2007

(54) Clothes Dryer Fire Alarm

(75) Inventor: Andrew Crnkovich, Elmhurst, IL (US)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Richmond, VA (US)

(21) Appl. No.: 11/564,549

(22) Filed: Nov. 29, 2006

Related U.S. Application Data
(60) Provisional application No. 60/741,938, filed on Dec. 2, 2005.

(51) Int. Cl. F26B 19/00

(52) U.S. Cl. 34/88; 34/89

(57) ABSTRACT

A clothes dryer having a carbon monoxide sensor incorporated therewith to detect the possibility and/or presence of a fire in the exhaust vent is provided. The dryer of the present invention incorporates carbon monoxide sensing to determine when an exhaust vent fire is likely or has occurred, and provides a warning to the consumer of the impending or existing hazardous condition. The warning may be audible, visual, and may include an interface to installed hazardous condition alarms within the dwelling. Additional interface to connected home systems providing text messaging may also be provided.

### CROSS-REFERENCE TO RELATED PATENT APPLICATIONS

This patent application claims the benefit of U.S. Provisional Patent Application No. 60/741,938, filed Dec. 2, 2005, the teachings and disclosure of which are hereby incorporated in their entireties by reference thereto.

### FIELD OF THE INVENTION

This invention generally relates to consumer and commercial appliances, and more particularly to consumer and commercial clothes dryers.

### BACKGROUND OF THE INVENTION

Clothes dryers are a leading cause of residential fires in the United States. In 1998 alone, the National Fire Protection Association (NFPA) reported 15 thousand dryer fires in the United States, resulting in approximately 300 injuries and over $75 million in direct property damage. The principal initial source of ignition for many of these fires is in the enclosed dryer vent stack. As such, traditional residential smoke alarms may not sound a warning until the fire is in an advanced state because the by-products of the combustion are vented outside the dwelling or structure.

There exists, therefore, a need in the art for a clothes dryer that can sense such a vent fire and provide adequate warning to the residents of the dwelling.

The invention provides such a clothes dryer. These and other advantages of the invention, as well as additional inventive features, will be apparent from the description of the invention provided herein.

### BRIEF SUMMARY OF THE INVENTION

In view of the above, embodiments of the present invention provide a new and improved consumer or commercial appliance that overcomes one or more of the problems existing in the art. More particularly, embodiments of the present invention provide a new and improved clothes dryer that can detect the possibility and/or presence of a vent fire.

In one embodiment of the present invention, a Carbon Monoxide (CO) sensor is incorporated into the clothes dryer to monitor CO gas levels in the dryer vent. On electric heat clothes dryers the presence of CO in the dryer vent could be indicative of a dryer fire, possibly caused by a build-up of dust and/or lint. In gas-fired dryers, the presence of elevated CO levels in the dryer vent, beyond that associated with normal operating conditions, could be associated with a potential fire condition.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric illustration of a clothes dryer constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

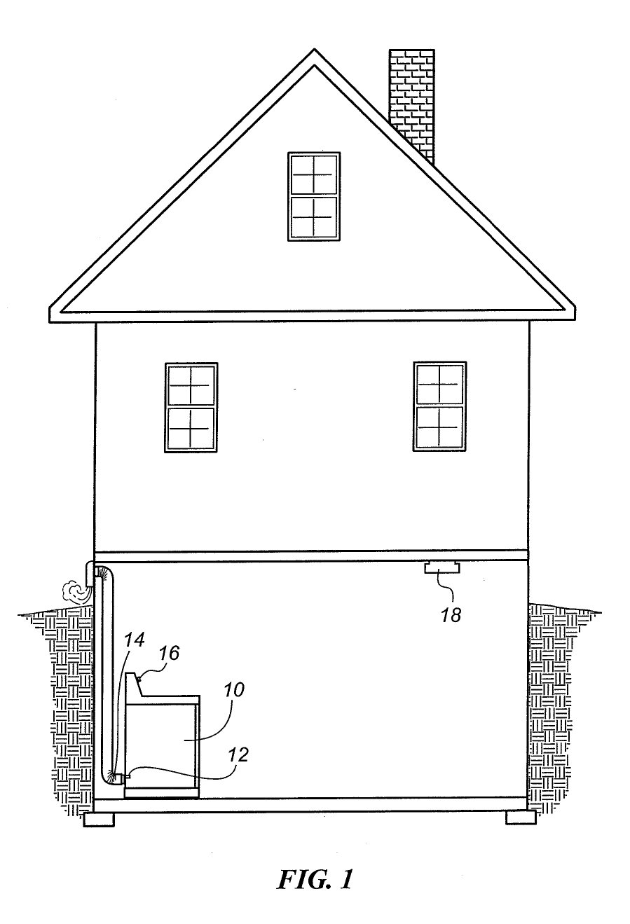

Referring to FIG. 1, a typical dwelling 20 is illustrated having a basement in which is installed a clothes dryer 10 constructed in accordance with an embodiment of the present invention. This clothes dryer 10 is controlled by a controller and includes a carbon monoxide sensor 12 positioned in relation to the exhaust vent 14 such that it is able to sense a flow of fluid therethrough. As is conventional, the exhaust vent 14 is vented outside of the dwelling 20.

In one embodiment the CO sensor is an electrochemical CO sensor 12. This CO sensor 12 is incorporated into the clothes dryer 10 near the exhaust vent that is coupled to the dryer vent 14. The CO sensor 12 continuously monitors the level of CO in the dryer vent 14, even when the dryer 10 is not in a drying mode of operation. When unusual levels of CO are detected that may indicate a problem condition, the sensor 12 can interrupt operation of the dryer 10. Typically, this would occur as a result of the CO sensor 12 sending a signal to the controller which, in turn, controls operation of the dryer 10.

On electric heat clothes dryers the presence of CO in the dryer vent could be indicative of a dryer fire, possibly caused by a build-up of dust and/or lint. In gas-fired dryers, the presence of elevated CO levels in the dryer vent, beyond that associated with normal operating conditions, could be associated with a potential fire condition. Therefore, for gas dryers, a threshold level is set above that which is expected during the drying operation that normally results from the burning of natural gas. In one embodiment, his threshold may be set to a level approximately ten percent about the normal amount expected during normal operation. Other embodiments may set the threshold higher to avoid false alarms that may result from less efficient, but still normal, burning of the gas, e.g. twenty percent, etc.

In one embodiment, the dryer 10 can sound a continuous or discontinuous audible warning to alert the homeowner to a potential problem. The alarm must be manually silenced in one embodiment. Additionally or alternatively, the dryer 10 may also enable a visual alarm indicator 16 (e.g. LED) to help the homeowner understand the nature of the alarm.

If the home is equipped with RF enabled smoke alarms 18, a signal is sent from the dryer 10 causing the alarms 18 to activate. If the home is equipped with a smart or connected home system, such as the Samsung Homevita system, a text message alerting the homeowner to the condition may also be sent over the gateway.

The dryer 10 preferably would incorporate a long-life CO sensor 12, such as a sensor that utilizes the Invensys Monox™ self-test technology, and would preferably be field serviceable. In the event the sensor 12 is not functioning, a visual and/or audible signal would alert the homeowner to replace the sensor. The dryer would continue to function normally in this condition in one embodiment, and would be disabled in an alternate embodiment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A clothes dryer, comprising:
an exhaust vent; and
a carbon monoxide (CO) sensor positioned relative to the exhaust vent to sense fluid flowing therethrough for a presence of CO.

2. The clothes dryer of claim 1, wherein the clothes dryer is a gas clothes dryer, and wherein operation of the dryer is interrupted when the CO sensor senses the presence of CO above a predetermined threshold.

3. The clothes dryer of claim 2, wherein the predetermined threshold is set above a level of CO that is expected to occur during a drying operation from burning of natural gas.

4. The clothes dryer of claim 3, wherein the predetermined threshold is set at least approximately 10% above the level of CO that is expected to occur during the drying operation from burning of natural gas.

5. The clothes dryer of claim 1, wherein the clothes dryer is an electric clothes dryer, and wherein operation of the dryer is interrupted when the CO sensor senses the presence of CO.

6. The clothes dryer of claim 1, wherein the CO sensor is an electrochemical CO sensor.

7. The clothes dryer of claim 1, further comprising an audible alarm, and wherein the audible alarm is triggered when the CO sensor detects the presence of CO.

8. The clothes dryer of claim 7, wherein the audible alarm provides a continuous audible warning.

9. The clothes dryer of claim 7, wherein the audible alarm provides a discontinuous audible warning.

10. The clothes dryer of claim 7, wherein the audible alarm is manually resettable.

11. The clothes dryer of claim 1, further comprising a visual alarm indicator, and wherein the visual alarm indicator is triggered when the CO sensor detects the presence of CO.

12. The clothes dryer of claim 11, wherein the visual alarm indicator is an light emitting diode (LED).

13. The clothes dryer of claim 1, further comprising a radio frequency (RF) transmitter that transmits an alarm activation signal to an external smoke detector to activate the audible warning of the external smoke detector.

14. The clothes dryer of claim 1, wherein the controller sends a text message alerting an external smart home system when CO is detected.

15. The clothes dryer of claim 1, wherein the CO sensor is a self-testing CO sensor.

16. The clothes dryer of claim 15, further comprising an audible alarm, and wherein the audible alarm is triggered when the self-testing CO sensor determines that it is not functioning properly.

17. The clothes dryer of claim 15, further comprising a visual alarm, and wherein the visual alarm is triggered when the self-testing CO sensor determines that it is not functioning properly.

18. The clothes dryer of claim 15, wherein operation of the clothes dryer is disabled when the self-testing CO sensor determines that it is not functioning properly.

19. A method of determining the presence of a fire in a clothes dryer vent, comprising the steps of:
monitoring air in the close dryer vent; and
providing a warning when the step of monitoring indicates that carbon monoxide is detected.

20. The method of claim 19, wherein the step of providing a warning when the step of monitoring indicates that carbon monoxide is detected comprises the step of providing a warning when the step of monitoring indicates that carbon monoxide is detected above a predetermined threshold.
